(19) United States
(12) Patent Application Publication
(10) Pub. No.: US 2004/0145902 A1
(43) Pub. Date: Jul. 29, 2004

(54) Heated mirror assembly

(76) Inventors: Daniel R. Todd, Sheboygan, WI (US); Allen A. Bukosky, Sheboygan, WI (US); Daniel J. Mathieu, Sheboygan Falls, WI (US)

Correspondence Address: WELLS ST. JOHN P.S., 601 W. FIRST AVENUE, SUITE 1300, SPOKANE, WA, 99201, US

(21) Appl. No.: 10/355,915

(22) Filed: Jan. 28, 2003

(51) Int. Cl. B60Q 1/26

(52) U.S. Cl. 362/494; 362/544; 362/140

(57) ABSTRACT

A heated mirror assembly is disclosed and which includes a mirror which is operable to both reflect and pass visibly discernible electromagnetic radiation; a first substrate bearing a heater is juxtaposed relative to the mirror, and wherein the heater, when energized, imparts heat energy to the mirror; an electrically conductive pathway is made integral with the first substrate; and an electrical device is electrically coupled to the conductive pathway, and wherein the heater and the electrical device are each energized from electrical terminals which are supported at least in part by the mirror.

### TECHNICAL FIELD

The present invention relates to a heated mirror assembly, and more specifically to a mirror assembly which has particular utility when coupled with the controls of an overland vehicle and the like, and which may, on the one hand, operate as a combined warning lamp and rearview mirror assembly, and which further has an integral heater which improves the usefulness and visibility of the mirror during certain inclement weather conditions.

### BACKGROUND OF THE INVENTION

The beneficial effects of employing auxiliary signaling assemblies have been disclosed variously in such U.S. Pat. Nos. as 5,014,167; 5,207,492; 5,788,357; 6,005,724; 6,045,243; 6,076,948; and 6,257,746 all of which are incorporated by reference herein. In several of the patents, noted above, the signaling assembly which is described includes, on the one hand, a dichroic mirror which is operable to pass predetermined bands of electromagnetic radiation; or on the other hand, a substantially neutrally chromatic mirror which has been altered in some fashion in order to allow visibly discernable electromagnetic radiation to pass therethrough. Still further, in each of the references noted above, an emitter of visibly discernable electromagnetic radiation, such as incandescent lamp, a light emitting diode or the like is provided, and which is mounted on a printed circuit board or similar assembly such that emitted visibly discernible electromagnetic radiation generated by the respective emitter(s) may pass through the mirror. The visible electromagnetic radiation passing through the mirror is in an amount and in an orientation such that may be viewed at remote locations by third party observers.

While each of the inventions disclosed in the patents noted above have operated with a great deal of success, the inventors have endeavored to improve upon this same technology in view of ongoing changes to overland vehicle designs and the perceived needs of manufacturers and consumers.

For example, in the case of passenger automobiles, recent style changes implemented on this class of platform and added mirror options have caused the volume of the exterior mirror housings to become smaller in size. A reduction in the volume of the exterior mirror has caused manufacturers of signaling assemblies such as what has been disclosed in the patents noted above, to reduce the size of many of the components utilized with same. Still further, these reduced mirror housing sizes have caused other problems inasmuch as each of the signaling assemblies, noted above, require that an electrical conduit be routed to same. In such close quarters, it is often difficult during assembly to make the appropriate electrical connections. Still further, there is a tendency, in such close quarters for electrical conduits or wire harnesses and the like which are required to be routed thereto to become damaged because of the bending and other manipulations that must be made to same in order to effectively route the electrical conduit to the signaling device. Still further, and during assembly, electrical conduits which are coupled to the signaling assemblies (often called “pigtails”) are viewed by many as nuisances and hindrances inasmuch as they interfere with some assembly steps because they are often in the way.

In the case of sport utility vehicles, a different problem has presented itself. In vehicles such as this, larger exterior mirrors have been employed. While this alleviates many of the spatial problems that are attendant with the smaller housings used on passenger vehicles, other issues arise with respect to the control of vibration within the mirror housing. As should be understood, these prior art signaling assemblies added weight to the mirror which was mounted in the mirror housing of the overland vehicle. In view of the fact that the mirror was unevenly weighted, and further in view of the fact that the mirror was cantilevered in a position outwardly from the vehicle, the unequally weighted mirror had a tendency to vibrate under some operational circumstances thus making a reflected image provided by the mirror less than desirable or completely unusable.

A heated mirror assembly which employs the teachings of the prior art references noted above but avoids the perceived shortcomings associated thereto is the subject matter of the present application.

### SUMMARY OF THE INVENTION

Therefore, one aspect of the present invention is to provide a heated mirror assembly which includes a mirror which is operable to both reflect and pass electromagnetic radiation, and which has an average reflectance of greater than about 35%; a first substrate bearing a heater which is juxtaposed relative to the mirror, and wherein the heater, when energized, imparts heat energy to the mirror; an electrically conductive pathway made integral with the first substrate; and an electrical device electrically coupled to the electrically conductive pathway, and wherein the heater and the electrical device are each energized from electrical terminals which are borne by the first substrate, and wherein the electrical device when energized emits electromagnetic radiation which is passed, in part, by the mirror.

Another object of the present invention relates to a heated mirror assembly which includes a mirror having opposite surfaces, and which is operable to both reflect, and pass electromagnetic radiation, and wherein the mirror has an average reflectance of greater than about 35%; an electrical circuit defining a heater, and a separate electrically conductive pathway, and which are both deposited on one of the surfaces of the mirror, and wherein the heater, when energized, imparts heat energy to the mirror; and an electrical device electrically coupled to the electrically conductive pathway, and wherein the heater and the electrical device are each energized from electrical terminals which are supported on one of the surfaces of the mirror, and wherein the electrical device, when energized, emits electromagnetic radiation which is passed, in part, by the mirror.

Still another aspect of the present invention relates to a heated mirror assembly which includes a mirror having opposite first and second surfaces and which is operable to both reflect and pass visibly discernible electromagnetic radiation, and which has an average reflectance of greater than about 35%; an electrical device, which when energized, emits visibly discernible electromagnetic radiation which is passed, at least in part, by the mirror, and wherein the electrical device is mounted on one of the surfaces of the mirror; an electrically conductive pathway made integral with one of the surfaces of the mirror, and wherein the electrically conductive pathway has a first end, and an opposite second end which is electrically coupled with the electrical device; and a heater circuit made integral with one of the surfaces of the mirror, and which, when energized, imparts heat energy to the mirror, and wherein the heater circuit, and the electrically conductive pathway each have electrical terminals which are supported by one of the surfaces of the mirror.

A further aspect of the present invention relates to a heated mirror assembly which includes a mirror having an outwardly facing surface, and an opposite inwardly facing surface, and wherein a mirror coating is applied to one of the surfaces, and wherein the mirror defines a region which passes visibly discernible electromagnetic radiation; a heater circuit disposed in heat transferring relation relative to the inwardly facing surface of the mirror, and which is juxtaposed relative to the inwardly facing surface, and wherein the heater circuit has electrical terminals to which electricity is supplied to energize the heater circuit; a plurality of electrical devices supported, in part, by the inwardly facing surface of the mirror, and which are located adjacent to the region which passes visibly discernibly electromagnetic radiation, and wherein the electrical devices, when energized, emit visibly discernible electromagnetic radiation which is passed, at least in part, by the mirror; an electrically conductive pathway coupled with the plurality of electrical devices, and which is operable to energize the respective electrical devices, and wherein the electrically conductive pathway is made integral with, and is supported along its length by the inwardly facing surface of the mirror, and wherein the electrically conductive pathway has electrical terminals to which electricity is selectively supplied to energize the plurality of electrical devices, and wherein the electrical terminals of the electrically conductive pathway are located adjacent to the electrical terminals of the heater circuit so as to facilitate the electrical coupling of the electrical devices, and the heater circuit with a source of electricity; and a reflector, supported in part, by the inwardly facing surface of the mirror, and which reflects visibly discernible electromagnetic radiation which is emitted by the plurality of electrical devices, and which is passed by the mirror and which can be view from a remote location.

These and other aspects of the present invention will be discussed in greater detail hereinafter.

### BRIEF DESCRIPTION OF THE DRAWINGS

Preferred embodiments of the invention are described below with reference being made to the following accompanying drawings.

FIG. 1 is a greatly enlarged, fragmentary, vertical sectional view of one form of the heated mirror assembly of the present invention.

FIG. 2 is a greatly simplified, fragmentary, exploded, perspective view of one form of the heated mirror assembly as shown in FIG. 1.

FIG. 3 is a fragmentary plan view of another form of the heated mirror assembly of the subject invention with some components removed in order to show the structure thereunder.

FIG. 4 is a greatly enlarged, fragmentary, vertical sectional view of another form of the heated mirror assembly of the present invention.

FIG. 5 is yet another greatly enlarged, fragmentary, vertical sectional view of another form of the heated mirror assembly of the present invention.

FIG. 6 is still another greatly enlarged, fragmentary, vertical sectional view of another form of the heated mirror assembly of the present invention.

FIG. 7 is a plan view of a substrate bearing a heater circuit and a conductive pathway and which is utilized in the heated mirror assembly of the present invention.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

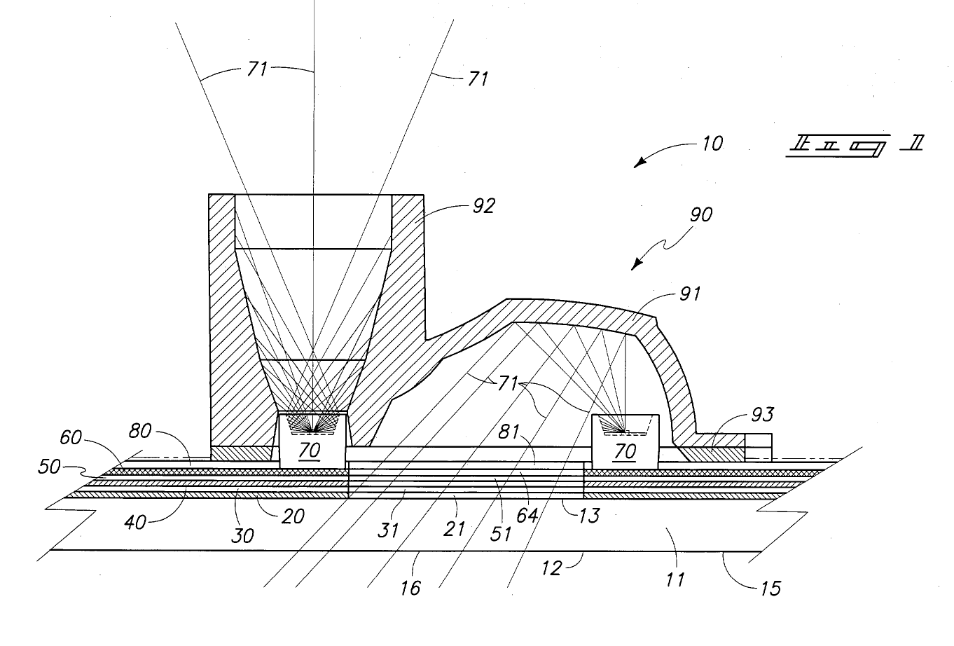

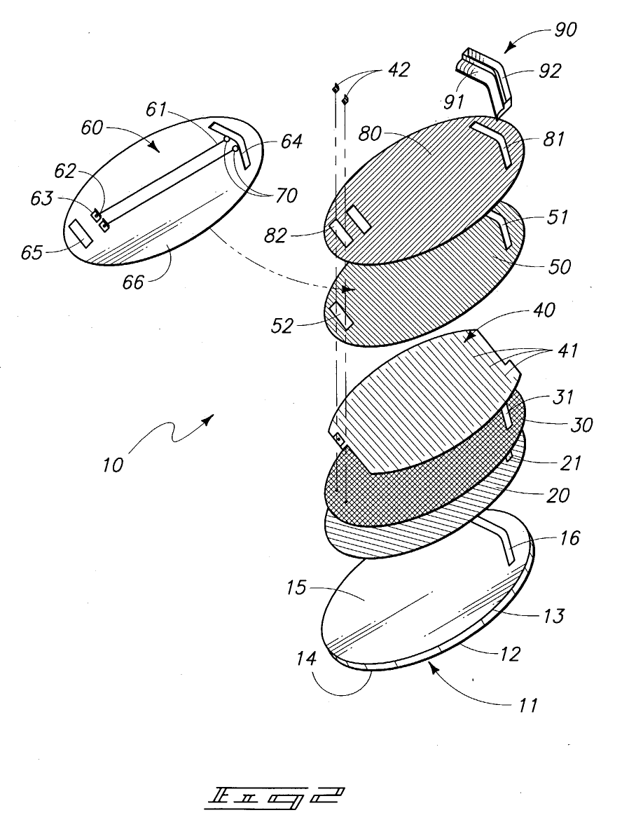

Referring more particularly to the drawings, the heated mirror assembly of the present invention is generally indicated by the numeral 10. As seen in FIG. 1 and following, the heated mirror assembly 10 of the present invention includes as a first component, a mirror which is generally indicated by the numeral 11. The mirror 11 has a first or outwardly facing surface 12 and an opposite second or inwardly facing surface 13. As seen more specifically in FIG. 2, a mirror coating 14 is provided and which is illustrated herein as being applied to the first or outwardly facing surface 12. It should be understood however, that the mirror coating may be applied to either the first or second surfaces depending upon the type of mirror coating employed and the purposes for the ultimate end product. As seen in FIG. 2, and which illustrates a mirror 11 which has a mirror coating comprising chromium and the like, the mirror 11 includes a primary region 15 which is operable to reflect visibly discernible electromagnetic radiation, and an adjacent secondary region 16 is provided and which is defined by the mirror coating and which passes visibly discernible electromagnetic radiation. As should be understood, the resulting mirror 11 has an average reflectance of greater than about 35% which renders it useful for use on overland vehicles of various types. While primary and secondary regions are shown in this form of the invention it is possible to fabricate a mirror as will be described below where nearly the entire surface of the mirror is operable to pass electromagnetic radiation. Therefore the word region should be construed in its broadest sense to cover this type of arrangement.

As should be understood from a study of the drawings, and from the teachings of the earlier discussed prior art patents, various mirrors 11 may be employed in the present invention with equal success. Such mirrors may include semi-transparent mirrors of various constructions. Still further, mirrors having various dichroic coatings as taught in the prior art may also be employed with equal success. Yet further, by reviewing the drawings, it will be seen that the primary region and the secondary regions 15 and 16 are substantially continuous, that is, there appears to be no substantial interruption or discontinuity in either of the regions. However, it will be recognized that it is certainly possible to fabricate a mirror having a primary region which is substantially continuous and a secondary region which is discontinuous. Such is seen in U.S. Pat. No. 6,076,948, the teachings of which are incorporated herein.

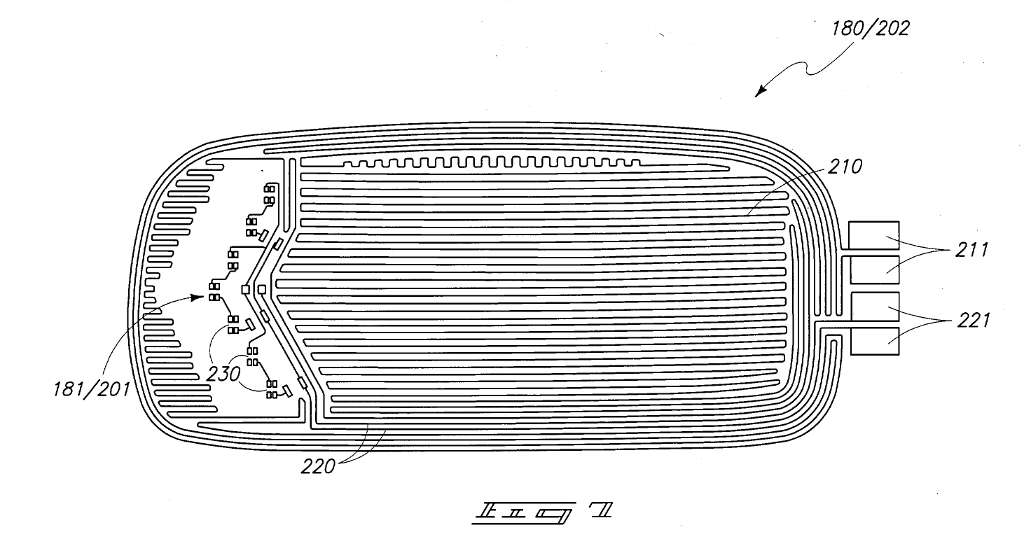

Referring now to FIGS. 1 and 2, a first form of the heated signal mirror 10 of the present invention is shown. As seen therein, the first form of the heated mirror assembly includes an adhesive layer 20 which is deposited in substantial covering relation relative to the second or inwardly facing surface 13 of the mirror 11. The adhesive layer 20 has a region 21 formed therein which permits visibly discernible electromagnetic radiation to pass therethrough. As seen in the drawings, the region 21 is disposed in substantial registry with the secondary region 16 which is defined by the mirror 11. The adhesive layer 20 affixes or otherwise makes integral with the second or inwardly facing surface 13, a flexible synthetic, non-electrically conductive substrate such as mylar. The flexible non-electrically conductive substrate has a region 31 formed therein and which allows visibly discernible electromagnetic radiation to pass therethrough. As with the adhesive layer 20, this region 31 is disposed in substantial registry with region 21, and the secondary region 16 which is defined by the mirror 11. Referring still to FIGS. 1 and 2, it will be seen that a heater circuit 40 is provided, and which is deposited or otherwise disposed in heat transferring relation relative to the second or inwardly facing surface 13 of the mirror 11. As will be seen in FIGS. 1 and 2, the heater circuit 40 is defined by a plurality of conductive traces 41 which are positioned in a given pattern on the flexible synthetic non-electrically conductive substrate 30. The conductive traces 41 may be deposited on the substrate 30, in any number of ways including by various printing techniques, vapor deposition or the like. The plurality of conductive traces 41 are coupled to a pair of electrical terminals which are generally indicated by the numeral 42. Electricity supplied to the terminals 42 energize the heater circuit 40 and produce heat energy which is transmitted to the mirror 11. This heat energy renders the mirror useful in various inclement weather situations. As will be seen by the exploded view of FIG. 2, the electrical terminals 42 are borne by or otherwise supported or mounted on the inwardly facing surface 13 of the mirror 11. However and as will be more fully discussed by reference to FIG. 7, the electrical terminals may be borne on a portion of the substrate 30 which extends beyond the edge of the mirror 11 and is therefore supported at least in part by the mirror 11.

Still referring to FIGS. 1 and 2, the first form of the heated mirror assembly 11 of the present invention is shown, and which further includes a first electrically insulating layer 50 which is deposited or otherwise positioned in substantially covering relation over the heater circuit 40. The first electrically insulative layer 50 has a region 51 formed therein and which allows the passage of visibly discernible electromagnetic radiation therethrough. This region 51 is positioned in substantial registry with the same regions 31, 21 and 16, which have been discussed, above. Yet further, an aperture 52 is formed in layer 50, and which allows the terminals 42 to extend therethrough.

An electrically conductive pathway which is generally indicated by the numeral 60, is made integral with a nonconductive supporting substrate 66. This supporting substrate 66 and electrically conductive pathway are juxtaposed relative to the first electrically insulative layer 50. The electrically conductive pathway 60 is coupled with a plurality of electrical devices which will be discussed below. As seen in FIG. 1, the electrically conductive pathway 60 is made integral with and is supported along its entire length by the inwardly facing surface 13 of the mirror 11. Still further, the electrically conductive pathway has a first end 61 which is located near the region 51 and which permits the passage of visibly discernible electromagnetic radiation. Still further, the electrically conductive pathway has an opposite second end 62. A pair of electrical terminals 63 are provided, and which are coupled to the second end thereof. As seen in the drawings, the electrical terminals 63 of the electrically conductive pathway 60 are located adjacent to the electrical terminals 42 of the heater circuit 40, when assembled, so as to facilitate the electric coupling of the electrical devices, as will be discussed below, and the heater circuit 40 with a source of electricity. The electrically conductive pathway 60 further defines a region 64 which also permits the passage of electromagnetic radiation. The region 64 is oriented in registry or alignment with the regions 51, 31, 21 and 16 as discussed above. Still further, an aperture 65 is formed in the electrically conductive pathway 60 and which permits the electrical terminals 42 to extend therethrough.

As seen in FIGS. 1, 2 and following, a plurality of electrical devices 70 are provided, and which are supported, in part, by the inwardly facing surface 13 of the mirror 11. As illustrated in FIG. 2, the plurality of electrical devices, here illustrated as light emitting diodes, are located adjacent to the regions 64, 51, 41, 31 21 and 16 which pass visibly discernible electromagnetic radiation. The electrical devices 70 are electrically coupled to the electrically conductive pathway 60, and further, when energized emit visibly discernible electromagnetic radiation 71 which is passed at least in part by the mirror 11. When passed by the mirror 11 or otherwise emitted, the visibly discernible electromagnetic radiation 71 can form various visual signals that can be useful in the operation of overland vehicles. As seen in FIG. 1 and following, it will be understood that the visibly discernible electromagnetic radiation 71 emitted by some of the electrical devices 70 are operable to be transmitted such that a visual signal can be seen from a position forward of the first or outwardly facing surface 12, and/or, in the alternative, forward of the second or inwardly facing surface 13. Such is accomplished by means of a reflector which will be discussed in greater detail hereinafter.

Still referring to FIGS. 1 and 2, it will be seen that a second electrically insulative layer 80 is deposited, coated or otherwise positioned in at least partial covering relation over the electrically conductive pathway 60. This second electrically insulative layer 80 similarly has a region 81 which is defined thereby and which allows the passage of electromagnetic radiation therethrough. The region 81 is disposed in substantial registry or coaxially alignment with the other similar regions, earlier discussed, and which perform substantially the same function. A pair of apertures 82 are formed in the second electrically insulative layer 80 and which permits the electrical terminals 42 and 62 to extend therethrough such that the electrical terminals can be easily accessed to allow for the selective energizing of the heater circuit 40. As should be recognized the electrical terminals are borne by a layer of material which is made integral with the inwardly facing surface 13 of mirror 11. This is in contrast to the prior art manufacturing techniques where a “pigtail” would be employed. In this prior art solution, the terminals would be supported on one end of an electrical conduit which would not be affixed to the mirror 11 except at its terminus or opposite end where it would be electrically coupled with the heater or the electrical devices 70.

Disposed in reflecting relation relative to the plurality of electrical devices 70 is a reflector which is generally indicated by the numeral 90. The reflector is supported, in part, by the inwardly facing surface of the mirror 13 and is operable to reflect visibly discernible electromagnetic radiation 71 which is emitted by the plurality of electrical devices 70. A portion of the electromagnetic radiation emitted by the plurality of emitters is reflected by the reflector and is allowed to pass through the various regions which permit the passage of electromagnetic radiation. The reflector 90 has first and second portions 91 and 92. The first portion 91 of the reflector 90 is positioned so as to reflect visibly discernible electromagnetic radiation 71 emitted by some of the electrical devices 70 in a direction so that it passes through the regions which pass visibly discernible electromagnetic radiation. Still further, the second portion 92 of the reflector is positioned so as to reflect visibly discernible electromagnetic radiation emitted by some of the electrical devices 70 in a direction so that it does not pass through the regions which pass visibly discernible electromagnetic radiation. An adhesive layer 93 is operable to secure the reflector 90 to the second electrically insulative layer 80. The reflector is illustrated as a unitary assembly, however it is possible to fabricate a reflector having individual portions which are disposed in an appropriate orientation relative to the electrical devices 70.

The form of the invention as shown in FIGS. 1 and 2 provides significant benefits and advantages not possible with the prior art signaling assemblies as illustrated in the earlier referenced prior art patents. For example, in relative comparison to the prior art devices, the present invention represents a weight savings of about 60% to 80%. The combined weight of the electrical devices 70, electrically conductive pathway 60 and heater circuit 40 is less than about 8 grams. In relative comparison to the prior art, these same assemblies would normally weigh in the range of greater than about 17 grams. Still further, the electrical devices 70 and the associated reflector 90 represent an optical stack. Prior art devices have an optical stack thickness dimension of greater than about 12 millimeters. The current invention permits this same optical stack to be reduced to about as little as 5 millimeters for particular applications. The weight of the present invention is normally less than about 8% of the weight of the mirror 11 by itself.

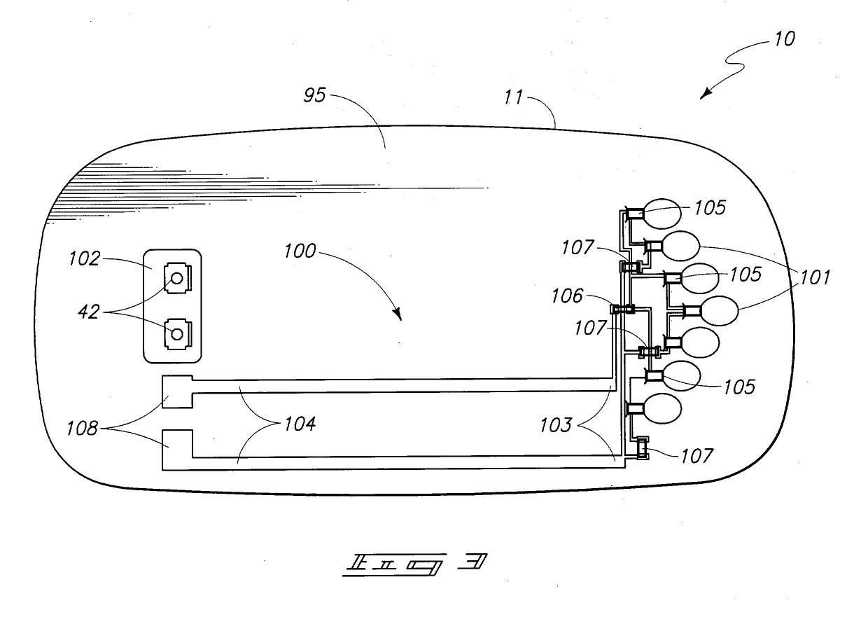

Referring now to FIG. 3, an alternative form of the earlier discussed electrically conductive pathway 60 is shown. A second electrically conductive pathway is generally indicated by the numeral 100. The view of FIG. 3 depicts a nonconductive supporting substrate 95 which supports the electrically conductive pathway 100. This plan view shows only the electrically conductive pathway 100, it being understood that other layers are positioned below the supporting substrate 95, and other surfaces or layers may be positioned above and in covering relation relative thereto in a fully assembled device 10. The electrically conductive pathway 100 includes a region 101, which is defined by a plurality of apertures, and which permit the passage of visibly discernible electromagnetic radiation therethrough. Still further the electrically conductive pathway 100 defines a second aperture 102 through which the electrical terminals 42 extend. This feature permits electrical power to be supplied to the underlying heater circuit 40 in a fashion similar to that seen in FIG. 2. The electrically conductive pathway has a first end 103 and an opposite second end 104. A plurality of conductive pads 105 are provided, and which are affixed at locations adjacent to the region 101. These electrically conductive pads are electrically coupled to the first end of the electrically conductive pathway such that electrical power can be supplied by way of the second electrically conductive pathway 100 to the individual conductive pads. A plurality of electrical devices 70 are individually electrically coupled to the respective electrically conductive pads (not shown). The electrical devices, such as LEDs, once affixed to the electrical pads can be energized by the second electrically conductive pathway 100. Positioned between the first end 103, and the electrically conductive pads 105 are several electrical components, including a plurality of resistors 107, and a rectifier diode 106. These electrical components provide the means by which electrical power supplied by way of the conductive pathway 100 can be delivered in appropriate amounts to the respective electrically conductive pads. A pair of terminals or contact pads 108 are made integral with the second end 104 of the electrically conductive pathway 100. As seen, the terminals 108 are positioned in closely adjacent relation relative to the terminals 42. This provides a convenient means by which the heated mirror assembly 10 may be conveniently electrically coupled to a remote power source, without the use of somewhat troublesome wire harnesses. As earlier discussed, wire harnesses or so called “pigtails” have proved to be bothersome in both assembly, and in the installation of the prior art devices.

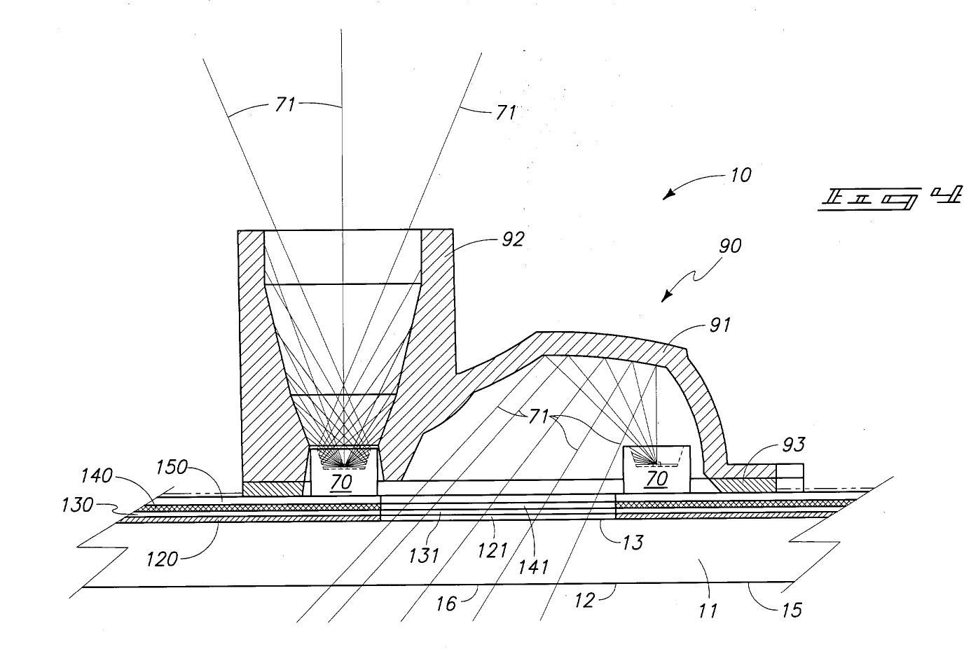

Referring now to FIG. 4, another alternative form of the invention is shown. In this form of the invention, a plurality of layers are provided and which are deposited by various coating or printing techniques such as by silk screening. One method of accomplishing this deposition is set forth in U.S. Pat. Nos. 6,386,741, and 6,462,468, the teachings of which are both incorporated herein. In this regard, it will be seen by a study of FIG. 4 that a first masking layer 120 is provided. This masking layer 120 defines a region 121 through which visibly discernible electromagnetic radiation 71 may pass. Deposited upon the masking layer 120 is a heater circuit which is generally indicated by the numeral 130. The heater circuit 130 is similarly applied by means of a coating or printing technique such as silk screen such that conductive traces (not shown) are deposited. The heater circuit 130 also defines a region 131 through which visibly discernible electromagnetic radiation may pass. The heater circuit 130 is otherwise operable to provide the benefits discussed with respect to the earlier forms of the invention. Deposited upon the heater circuit 130 is an electrically insulative layer 140. The electrically insulative layer 140 defines a region 141 through which visibly discernible electromagnetic radiation 71 may pass. Deposited upon the electrically insulative layer 140 is an electrically conductive pathway which is generally indicated by the numeral 150. The electrically conductive pathway 150 functions in substantially the same manner as earlier disclosed with respect to the electrically conductive pathway 60. The electrically conductive pathway 150 is deposited by various techniques including silk screening, vapor deposition and the like. As seen in FIG. 4, a plurality of electrical devices 70 are provided and which are electrically coupled to the electrically conductive pathway 150. When energized, the electrical devices 70 emit visibly discernible electromagnetic radiation 71 which passes at least in part through the regions 121, 131, 141 and 151 such that the visibly discernible electromagnetic radiation 71 may be seen from a remote location. Still further, a reflector 90 is provided and also provides the same benefits as earlier discussed in this application.

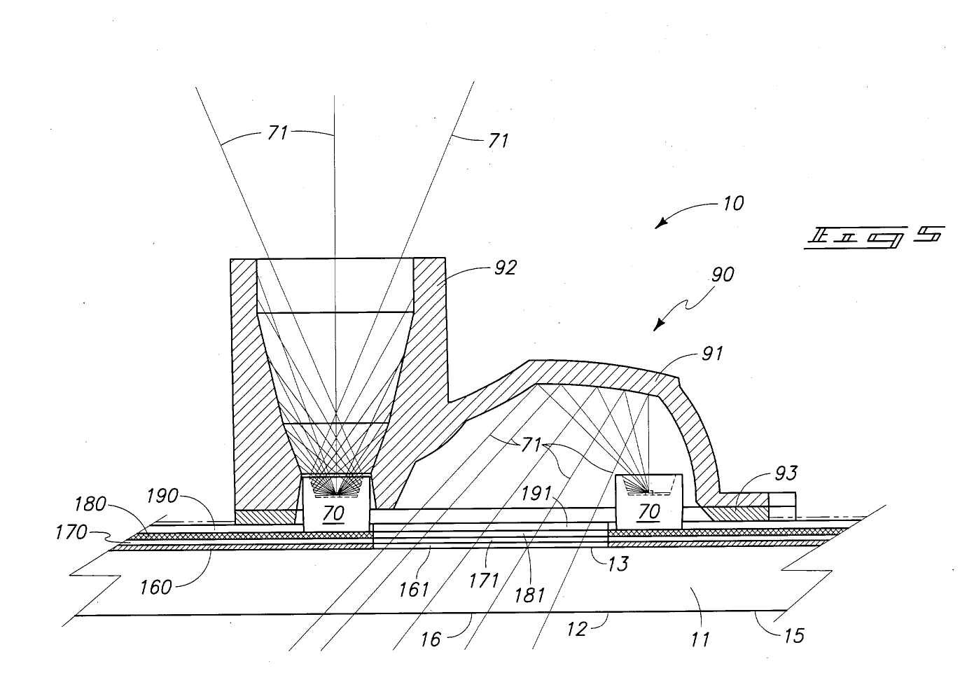

Another form of the invention is seen by a study of FIG. 5. This form of the invention includes an adhesive layer 160 which is deposited on the second or inwardly facing surface 13 of the mirror and which also defines a region 161 through which visibly discernible electromagnetic radiation may pass. Deposited upon the adhesive layer 160 is a flexible substrate 170 which may be fabricated from various synthetic substrates such as Mylar and the like. The adhesive layer 160 thereby renders the flexible substrate 170 substantially integral with the underlying mirror 11. The flexible substrate 170 defines a region 171 through which visibly discernible electromagnetic radiation 71 may pass. This region 171 is disposed in substantial registry with the region 161. Formed or otherwise deposited on the flexible substrate 170 is a combined heater circuit and conductive pathway 180 which is best illustrated by a study of FIG. 7. It should be understood that the combined heater circuit and conductive pathway may be formed on the same side of the flexible substrate 170, or on the opposite sides thereof. This combined heater circuit and conductive pathway 180 is formed in a number of conventional ways well known in the art. The combined heater circuit, and conductive pathway 180 defines a region 181, through which electromagnetic radiation may pass. Deposited in substantially covering relation over the combined heater circuit and conductive pathway 180 is an electrically insulative layer 190. The electrically insulative layer similarly has a region 191 through which electromagnetic radiation 71 will pass. This region 191 is substantially coaxial aligned with the other regions 181, 171 and 161, respectively. In the present form of the invention as seen in FIG. 5, the heated mirror assembly 10 also includes electrical devices 70 for emitting visibly discernible electromagnetic radiation 71 which is passed at least in part by the mirror 11. A corresponding reflector 90 for directing portions of electromagnetic radiation 171 in various orientations relative to the mirror 11 is also provided. As will be recognized, the electrical devices 70 are electrically coupled with the underlying combined heater circuit and conductive pathway 180 as will be discussed more fully below, and by reference to FIG. 7.

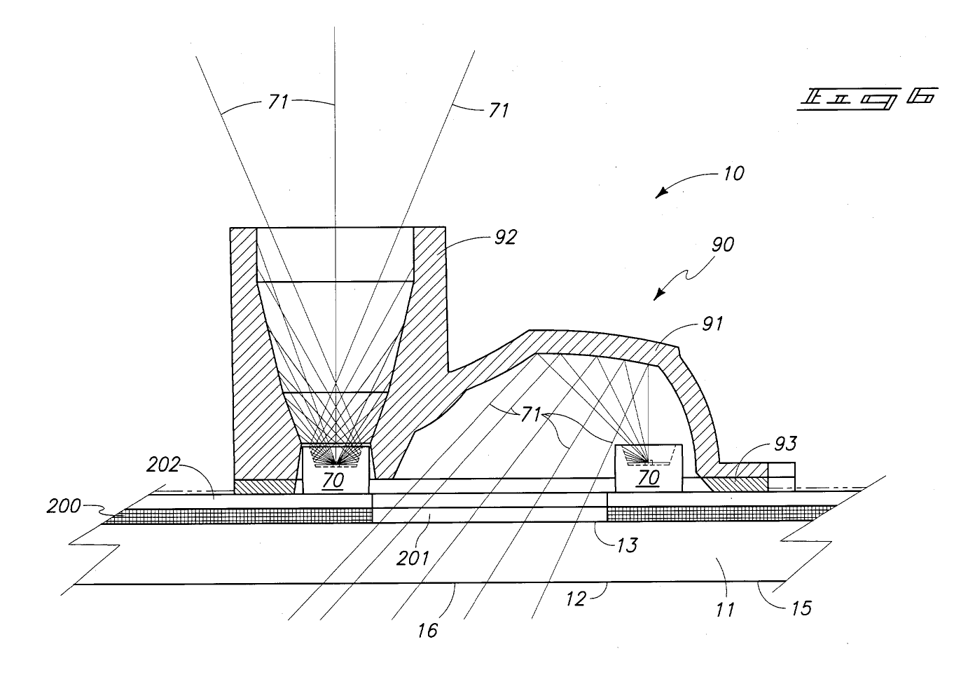

Referring now to FIG. 6, still another embodiment of the present invention is shown. As seen therein, the heated mirror assembly 10 includes a masking layer 200 which is deposited by various techniques including coating and silk screening onto the second inwardly facing surface 13 of the mirror 11. The masking layer 200 defines a region 201 through which visibly discernible electromagnetic radiation may pass. Deposited or otherwise printed or formed on the masking layer 200 is a combined heater circuit and conductive pathway 202 and which is seen most clearly by reference to FIG. 7. The form of the invention as seen in FIG. 6 operates in a fashion similar to the earlier forms of the invention inasmuch as the electrical devices 70 are electrically coupled to the combined printed heater circuit and conductive pathway 202 such that when energized, electromagnetic radiation 71 may be emitted and which passes, at least in part, through the region 201 which is defined by the masking layer 200. The form of the invention as shown in FIG. 6 similarly has a reflector 90 as earlier described and which directs emitted electromagnetic radiation 71 in various directions relative to the mirror 11.

Referring now to FIG. 7, the combined heater circuit and electrically conductive pathway 180 or 202 is shown more clearly in this plan view as it would be deposited on a supporting substrate 170 or the like. As seen, the combined heater circuit and conductive pathway includes a heater circuit component 210 having a pair of electrical terminals 211 connected thereto, and an electrically conductive pathway 220 also having a pair of electrically conductive terminals 221 attached thereto. As will be recognized, a plurality of electrically conductive pads 230 are distributed in an appropriate orientation along the region 181 or 201 and which allows the passage of visibly discernible electromagnetic radiation therethrough. The various electrical components 70, earlier discussed, as well as the resistors and the rectifier diodes have been removed, in order to facilitate an understanding of the drawing. As will be recognized, the electrical terminals 211 and 221 are oriented in an adjacent relation thereby facilitating the coupling of same to a remote electrical power source. Still further and as earlier discussed the electrically terminals 211 and 221 are supported on the flexible substrate 170, and would in this form of the invention extend beyond the edge of the mirror 11. In this arrangement, the terminals 211 and 221 are supported, in part, by the mirror 11, but are otherwise accessible so that electrical power may be applied to same. This arrangement eliminates the bothersome “pigtail” arrangement used in the prior art and which would often interfere in the manufacturing and installation of prior art signaling assemblies.

### OPERATION

The operation of the described embodiment of the present invention is believed to be readily apparent and is briefly summarized at this point. A heated mirror assembly 10 of the present invention is best understood by a study of FIG. 1 and following, and wherein a mirror 11 is operable to both reflect and pass visibly discernible electromagnetic radiation 71; a first substrate such as 30, 120, 160 or 200 is provided and which is juxtaposed relative to the mirror 11, and wherein the heater 40, 80, 202 when energized, imparts heat energy to the mirror; a conductive pathway 60, 220 is provided and which is made integral with the first substrate; and an electrical device 70 is coupled to the conductive pathway, and wherein the heater and the electrical device are each energized from electrical terminals 42, 62 which are borne by the first substrate. The terminals may be positioned on the mirror 11 or extend beyond the edge of the mirror. In either case the terminals will be supported at least in part by the mirror 11.

More specifically, a heated mirror assembly 10 of the present invention includes a mirror 11 having an outwardly facing surface 12, and an opposite inwardly facing surface 13, and wherein a mirror coating 14 is applied to one of the surfaces, and wherein the mirror defines a region 16 which passes visibly discernible electromagnetic radiation 71. A heater circuit such as exemplified by 60, 130, 180, or 202 is disposed in heat transferring relation relative to the inwardly facing surface of the mirror. The heater circuit is juxtaposed relative to the inwardly facing surface of the mirror, and further has electrical terminals such as exemplified by 42 and 211, for example to which electricity is supplied to energize the heater circuit. The electrical terminals of the heater circuit are borne at least partially by the inwardly facing surface of the mirror.

A plurality of electrical devices 70 are supported, in part, by the inwardly facing surface 13 of the mirror 11, and are located adjacent to those regions such as 16, 21, 31, and others, which pass visibly discernible electromagnetic radiation. The electrical devices 70, when energized, emit visibly discernible electromagnetic radiation 71 which is passed, at least in part by the mirror 11. An electrically conductive pathway such as exemplified by the numerals 60, 100 and 220, for example, are operable to energize the respective electrical devices 70. The electrically conductive pathway is made integral with, and is supported along its length by the inwardly facing surface 13 of the mirror 11. As earlier discussed, the electrically conductive pathway has electrical terminals such as for example 108 and 221 to which electricity is selectively supplied to energize the plurality of electrical devices 70. The electrical terminals of the electrically conductive pathway are located adjacent to the electrical terminals 42, 211 (FIG. 3, FIG. 7) of the heater circuit 40 so as to facilitate the electrical coupling of the electrical devices 70 and heater circuit with a source of electricity. A reflector 90 is provided, and supported, in part, by the inwardly facing surface of the mirror 13. The reflector reflects visibly discernible electromagnetic radiation 71 which is emitted by the plurality of electrical devices 70. This visibly discernible electromagnetic radiation is passed, at least in part, by the mirror 11 and can be viewed from a remote location.

Therefore, it will be seen that the heated mirror assembly 10 of the present invention addresses many of the perceived shortcomings associated with the prior art devices and practices while providing a heated mirror assembly which also has visual signaling capabilities. Yet further, the present invention also provides significant weight, space, and manufacturing cost advantages in relative comparison to the prior art assemblies.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

I/We claim:

1. A heated mirror assembly, comprising:
a mirror which is operable to both reflect and pass electromagnetic radiation, and which has an average reflectance of greater than about 35%;
a first substrate bearing a heater which is juxtaposed relative to the mirror, and wherein the heater, when energized, imparts heat energy to the mirror;
an electrically conductive pathway made integral with the first substrate; and
an electrical device electrically coupled to the electrically conductive pathway, and wherein the heater and the electrical device are each energized from electrical terminals which are borne by the first substrate, and wherein the electrical device, when energized, emits electromagnetic radiation which is passed, at least in part, by the mirror.

2. A heated mirror assembly as claimed in claim 1, and wherein the mirror is a semitransparent mirror.

3. A heated mirror assembly as claimed in claim 1, and wherein the mirror is a dichroic mirror.

4. A heated mirror assembly as claimed in claim 1, and wherein the mirror has a primary region which reflects visibly discernible electromagnetic radiation, and an adjacent secondary region which passes visibly discernible electromagnetic radiation.

5. A heated mirror assembly as claimed in claim 4, and wherein the primary region of the mirror is substantially continuous, and the secondary region is discontinuous.

6. A heated mirror assembly as claimed in claim 4, and wherein both the primary and secondary regions of the mirror are substantially continuous.

7. A heated mirror assembly as claimed in claim 1, and wherein the first substrate is a flexible synthetic substrate having opposite sides, and wherein the heater is defined by a plurality of conductive traces which are deposited on one side of the first flexible synthetic substrate.

8. A heated mirror assembly as claimed in claim 1, and wherein the first substrate is a flexible synthetic substrate having a first surface which has an adhesive coating deposited thereon, and an opposite second surface, and wherein the heater is defined by a plurality of conductive traces which are deposited on one of the first or second sides of the first flexible synthetic substrate, and wherein the adhesive coating adheres a preponderance of the flexible synthetic substrate to the mirror and places the heater into heat transferring relation relative thereto.

9. A heated mirror assembly as claimed in claim 8, and wherein the first flexible synthetic substrate has a region which passes visibly discernible electromagnetic radiation.

10. A heated mirror assembly as claimed in claim 8, and further comprising:
a first, flexible, electrically nonconductive layer positioned in substantially covering relation over the conductive traces, and wherein the electrically nonconductive layer has a region which passes visibly discernible electromagnetic radiation.

11. A heated mirror assembly as claimed in claim 1, and wherein the conductive pathway is borne by a second flexible substrate, and wherein the second flexible substrate is made integral with the first substrate.

12. A heated mirror assembly as claimed in claim 11, and wherein the second flexible substrate has a region which passes visibly discernible electromagnetic radiation, and wherein the conductive pathway has an end which is located at a position which is adjacent to the region which passes visibly discernible electromagnetic radiation.

13. A heated mirror assembly as claimed in claim 12, and wherein the electrical device is electrically coupled to the end of the conductive pathway, and wherein the electrical device, when energized, emits visibly discernible electromagnetic radiation which passes through the region of the second flexible substrate that passes visibly discernible electromagnetic radiation.

14. A heated mirror assembly as claimed in claim 13, and further comprising:
a second flexible electrically nonconductive layer positioned in at least partial covering relation relative to the conductive pathway.

15. A heated mirror assembly as claimed in claim 1, and wherein a reflector is mounted adjacent to the electrical device, and is operable to direct a portion of the emitted electromagnetic radiation in a predetermined direction so that it is not passed by the mirror.

16. A heated mirror assembly:
a mirror having opposite surfaces, and which is operable to both reflect and pass electromagnetic radiation, and wherein the mirror has an average reflectance of greater than about 35%;
an electrical circuit defining a heater, and a separate electrical pathway and which are both deposited on one of the surfaces of the mirror, and wherein the heater, when energized, imparts heat energy to the mirror; and
an electrical device electrically coupled to the electrical pathway, and wherein the heater and the electrical device are each energized from electrical terminals which are supported on one of the surfaces of the mirror, and wherein the electrical device, when energized, emits electromagnetic radiation which is passed, in part, by the mirror.

17. A heated mirror assembly as claimed in claim 16, and wherein the mirror is semitransparent.

18. A heated mirror assembly as claimed in claim 16, and wherein mirror is a dichroic mirror.

19. A heated mirror assembly as claimed in claim 16, and wherein the mirror has a primary region which reflects visibly discernible electromagnetic radiation, and an adjacent secondary region which passes visibly discernible electromagnetic radiation.

20. A heated mirror assembly as claimed in claim 19, and wherein the primary region of the mirror is substantially continuous, and the secondary region is discontinuous.

21. A heated mirror assembly as claimed in claim 19, and wherein both the primary and secondary regions of the mirror are substantially continuous.

22. A heated mirror assembly as claimed in claim 16, and further comprising:
a first masking layer deposited on one of the surfaces of the mirror, and wherein the masking layer defines a region through which visible electromagnetic radiation may pass, and wherein the electrical circuit is deposited on the masking layer.

23. A heated mirror assembly as claimed in claim 16, and further comprising:
a first, electrically nonconductive masking layer deposited on one of the surfaces of the mirror, and wherein the masking layer defines a region through which visible electromagnetic radiation may pass, and wherein that portion of the electrical circuit defining the heater is deposited on the masking layer; and
an electrically insulating layer deposited in at least partial covering relation over a portion of the electrical circuit defining the heater, and wherein that portion of the electrical circuit defining the separate electrical pathway is supported on the electrically insulating layer, and wherein the electrically insulating layer defines a region through which visible electromagnetic radiation may pass, and which is oriented in substantial registry with the same region which is defined by the masking layer.

24. A heated mirror assembly as claimed in claim 22, and wherein the conductive pathway has an end which is located adjacent to the region of the masking layer which passes visibly discernible electromagnetic radiation, and wherein the electrical device is electrically coupled to the end of the conductive pathway, and which, when energized emits visibly discernible electromagnetic radiation.

25. A heated mirror assembly as claimed in claim 23, and wherein the electrical device includes a plurality of electrical devices which emit visibly discernible electromagnetic radiation and wherein a portion of the visibly discernible electromagnetic radiation which is emitted by the plurality of electrical devices passes through the region of the masking layer which passes visibly discernible electromagnetic radiation.

26. A heated mirror assembly as claimed in claim 25, and wherein a reflector having first and second portions is borne by the mirror, and wherein the first portion of the reflector is positioned so as to reflect visibly discernible electromagnetic radiation emitted by some of the electrical devices in a direction so that it passes through the regions which pass visibly discernible electromagnetic radiation, and the second portion of the reflector is positioned so as to reflect visibly discernible electromagnetic radiation emitted by some of the electrical devices in a direction so that it does not pass through the regions which pass visibly discernible electromagnetic radiation.

27. A heated mirror assembly comprising:
a mirror having opposite first and second surfaces and which is operable to both reflect and pass visibly discernible electromagnetic radiation, and which has an average reflectance of greater than about 35%;
an electrical device which when energized emits visibly discernible electromagnetic radiation which is passed, at least in part, by the mirror, and wherein the electrical device is mounted on one of the surfaces of the mirror;
an electrically conductive pathway made integral with one of the surfaces of the mirror, and wherein the electrically conductive pathway has a first end, and an opposite second end which is electrically coupled with the electrical device; and
a heater circuit made integral with one of the surfaces of the mirror, and which when energized imparts heat energy to the mirror, and wherein the heater circuit and the electrically conductive pathway each have electrical terminals which are supported at least in part by one of the surfaces of the mirror.

28. A heated mirror assembly as claimed in claim 27, and further comprising:
a first layer of material which is made integral with one of the surfaces of the mirror, and which defines a region through which visibly discernible electromagnetic radiation may pass, and wherein the electrically conductive pathway and the heater circuit are made integral with the first layer.

29. A heated mirror assembly as claimed in claim 28, and wherein the first layer is a synthetic substrate having a first surface which is adhesively affixed to one of the surfaces of the mirror, and an opposite second surface, and wherein the electrically conductive pathway, and the heater circuit are made integral with one of the surfaces.

30. A heated mirror assembly as claimed in claim 28, and wherein the first layer is a masking layer which is deposited onto one of the surfaces of the mirror, and wherein the electrically conductive pathway, and the heater circuit are made integral with the masking layer.

31. A heated mirror assembly as claimed in claim 28, and wherein the first end of the electrically conductive pathway is located in a given location relative to the mirror surface, and wherein the electrical terminal of the electrically conductive pathway are electrically coupled to the first end.

32. A heater mirror assembly as claimed in claim 27, and further comprising:
a reflector located adjacent to the electrical device so as to direct at least a portion of the visibly discernible electromagnetic radiation emitted by the electrical device so that it may pass through the mirror.

33. A heater assembly as claimed in claim 27, and wherein the electrical device is a plurality of electrical devices, and wherein a reflector having first and second portions is positioned adjacent to the plurality of electrical devices, and wherein the first portion of the reflector is positioned so as to reflect visibly discernible electromagnetic radiation emitted by some of the electrical devices in a direction so that it passes through the mirror, and the second portion of the reflector is positioned so as to reflect visibly discernible electromagnetic radiation emitted by some of the electrical devices in a direction so that it does not pass through the mirror.

34. A heated mirror assembly as claimed in claim 27, and further comprising:
a first layer of material which is made integral with one of the surfaces of the mirror, and which defines a region through which visibly discernible electromagnetic radiation may pass, and wherein the heater circuit is made integral with this first layer.

35. A heated mirror assembly as claimed in claim 34, and wherein the first layer of material is a masking layer which is printed onto one of the surfaces of the mirror, and wherein the masking layer defines a region through which visibly discernible electromagnetic radiation may pass.

36. A heated mirror assembly as claimed in claim 34, and wherein the first layer of material is a synthetic substrate which is adhesively affixed to one of the surfaces of the mirror and which defines a region through which visibly discernible electromagnetic radiation may pass.

37. A heated mirror assembly as claimed in claim 34, and further comprising:
a first, electrically insulating layer positioned in substantially covering relation over the heater circuit, and wherein the electrically insulating layer has a region which passes visibly discernible electromagnetic radiation and which is oriented in substantial registry with the same region defined by the first layer, and wherein the electrically conductive pathway is borne by the first electrically insulating layer.

38. A heated mirror assembly as claimed in claim 37, and further comprising:
a second, electrically insulating layer positioned in at least partial covering relation relative to the electrically conductive pathway, and wherein the second, electrically insulating layer defines a region through which visibly discernibly electromagnetic radiation may pass, and which is disposed in substantial registry with the same region defined by the first, electrically insulating layer, and the first layer.

39. A heated mirror assembly as claimed in claim 38, and wherein the electrical device is mounted on the mirror and located adjacent to the regions which pass visibly discernible electromagnetic radiation.

40. A heated mirror assembly as claimed in claim 27, and wherein a reflector is positioned adjacent to the electrical device to reflect electromagnetic radiation emitted by the electrical device in a direction so that it may pass, at least in part through the mirror.

41. A heated mirror assembly as claimed in claim 40, and wherein combined weight of the electrical device, electrically conductive pathway, and the heater circuit is less than about 8 grams.

42. A heated mirror assembly as claimed in claim 40, and wherein the combined weight of the electrical device, electrically conductive pathway and the heater circuit is less than about 8% of the weight of the mirror.

43. A heated mirror assembly as claimed in claim 40, and wherein the electrical device and the reflector comprise an optical stack which has a thickness dimension of less than about 10 millimeters.

44. A heated mirror assembly, comprising:
a mirror having an outwardly facing surface, and an opposite inwardly facing surface, and wherein a mirror coating is applied to one of the surfaces, and wherein the mirror further comprises a region which passes visibly discernible electromagnetic radiation;
a heater circuit disposed in heat transferring relation relative to the inwardly facing surface of the mirror, the heater circuit juxtaposed relative to the inwardly facing surface and which further has electrical terminals to which electricity is supplied to energize the heater circuit;
a plurality of electrical devices supported in part by the inwardly facing surface of the mirror and which are located adjacent to the region which passes visibly discernible electromagnetic radiation, and wherein the electrical devices, when energized emit visibly discernible electromagnetic radiation which is passed, at least in part, by the mirror;
an electrically conductive pathway coupled with the plurality of electrical devices, and which is operable to energize the respective electrical devices, and wherein the electrically conductive pathway is made integral with, and is supported along its length by the inwardly facing surface of the mirror, and wherein the electrically conductive pathway has electrical terminals to which electricity is selectively supplied to energize the plurality of electrical devices, and wherein the electrical terminals of the electrically conductive pathway are located adjacent to the electrical terminals of the heater circuit so as to facilitate the electrical coupling of the electrical devices and the heater circuit with a source of electricity; and
a reflector, supported in part by the inwardly facing surface of the mirror, and which reflects visibly discernible electromagnetic radiation which is emitted by the plurality of electrical devices, and which is passed by the mirror and which can be view from a remote location.

45. A heated mirror assembly as claimed in claim 44, and wherein the heater circuit is supported by a layer of material, and which is made integral with the inside facing surface of the mirror, and wherein the electrically conductive pathway is supported by the same layer of material.

46. A heated mirror assembly as claimed in claim 44, and wherein the heater circuit is supported by a first layer of material, and wherein the electrically conductive pathway is supported on a second layer of material and wherein both layers are made integral with the inside facing surface of the mirror.

47. A heated mirror assembly as claimed in claim 45, and wherein the first layer of material is adhesively affixed to the inwardly facing surface of the mirror.

48. A heated mirror assembly as claimed in claim 45, and wherein the layer of material is applied to the inside facing surface of the mirror as a coating.
